(19) United States
(12) Patent Application Publication
(10) Pub. No.: US 2014/0214256 A1
(43) Pub. Date: Jul. 31, 2014

(54) STEERING SYSTEM FOR AN AUTONOMOUSLY DRIVEN VEHICLE AND METHODS OF STEERING THE SAME

(71) Applicant: GM GLOBAL TECHNOLOGY OPERATIONS LLC, Detroit, MI (US)

(72) Inventors: Kenneth L. Rosol, Clinton Township, MI (US); David M. Sidlosky, Beverly Hills, MI (US); Robert W. Leschuk, Oxford, MI (US); Eric L. Raphael, Birmingham, MI (US); Scott R. Kloess, Rochester Hills, MI (US); Yat-Chung Tang, Rochester, MI (US); John T. Zuzelski, Clarkston, MI (US)

(73) Assignee: GM GLOBAL TECHNOLOGY OPERATIONS LLC, Detroit, MI (US)

(21) Appl. No.: 13/750,408

(22) Filed: Jan. 25, 2013

(51) Int. Cl. G05D 1/02

(52) U.S. Cl. CPC G05D 1/021
USPC 701/23

(57) ABSTRACT

A steering system for an autonomously driven vehicle and methods of steering the vehicle are disclosed. A brake device is operable in a first phase to brake the vehicle when a power steering controller is in a first mode and operable in a second phase to steer the vehicle when the power steering controller is in a second mode. A main controller is in communication with a friction device to signal the friction device to actuate to a disengaged position when the power steering controller is in the first mode and the brake device is in the first phase, and signal the friction device to actuate to an engaged position to secure a steering wheel in an initial position when the power steering controller is in the second mode and the brake device is in the second phase to allow the brake device to steer the vehicle.

### TECHNICAL FIELD

The present disclosure relates to a steering system for an autonomously driven vehicle and methods of steering the autonomously driven vehicle.

### BACKGROUND

Autonomously driven vehicles are being developed to navigate the vehicle without a human driver steering the vehicle. Various components, such as visual sensors, are being developed to guide the autonomously driven vehicle along the roads, identify surrounding vehicles and maintain the vehicle within its lane.

### SUMMARY

The present disclosure provides a steering system for an autonomously driven vehicle. The steering system includes a steering assembly, with the steering assembly including a steering wheel rotatable about a longitudinal axis. The steering system also includes a power steering controller coupled to the steering assembly and having a first mode and a second mode. The steering system further includes a main controller in communication with the power steering controller. In addition, the steering system includes a brake system in communication with the main controller. The brake system includes a brake device in communication with the main controller. The brake device is operable in a first phase to brake the vehicle when the power steering controller is in the first mode and a second phase to steer the vehicle when the power steering controller is in the second mode. The steering system further includes a friction device coupled to the steering assembly. The friction device is movable between a disengaged position releasing the steering assembly to allow rotation of the steering wheel about the longitudinal axis and an engaged position engaging the steering assembly to secure the steering wheel in an initial position. The main controller is in communication with the friction device to signal the friction device to actuate to the disengaged position when the power steering controller is in the first mode and the brake device is in the first phase, and signal the friction device to actuate to the engaged position to secure the steering wheel in the initial position when the power steering controller is in the second mode and the brake device is in the second phase to allow the brake device to steer the vehicle.

The present disclosure also provides a method of steering an autonomously driven vehicle. The method includes determining that a power steering controller is in one of a first mode and a second mode different from the first mode. A main controller is signaled that the power steering controller is in the first mode. A brake device is signaled, via the main controller, to operate in a first phase in response to the power steering controller being in the first mode. A friction device is signaled, via the main controller, to operate in a disengaged position in response to the power steering controller being in the first mode such that a steering wheel is rotatable. The method further includes signaling the main controller that the power steering controller is in the second mode. The brake device is signaled, via the main controller, to switch from the first phase to operate in a second phase in response to the power steering controller being in the second mode such that the brake device steers the vehicle in the second phase. The friction device is actuated from the disengaged position to the engaged position in response to the power steering controller being in the second mode. A steering assembly is engaged with the friction device when the friction device is in the engaged position to secure the steering wheel in an initial position such that the brake device steers the vehicle in the second phase.

The present disclosure provides another method of steering an autonomously driven vehicle. At least one of a first brake and a second brake is actuated to generate at least one yaw moment to steer the vehicle when an interruption occurs in the primary steering of the vehicle. A steering assembly is engaged with a friction device to secure a steering wheel in an initial position when actuating the at least one of the first and second brakes to steer the vehicle.

Accordingly, this steering system provides a back-up system for the primary steering of the autonomously driven vehicle which allows the brake system to steer the vehicle in certain situations, such as, when the interruption occurs in the primary steering. For example, at least one yaw moment generated by the brake system will steer the vehicle while the friction device secures the steering wheel in the initial position.

The detailed description and the drawings or Figures are supportive and descriptive of the disclosure, but the scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic top view diagram of a steering system for an autonomously driven vehicle.

FIG. 2 is a schematic perspective view of a steering assembly.

FIG. 3 is a schematic flowchart of a method of steering the vehicle of FIGS. 1 and 2.

FIG. 4 is a schematic flowchart of another method of steering the vehicle of FIGS. 1 and 2.

### DETAILED DESCRIPTION

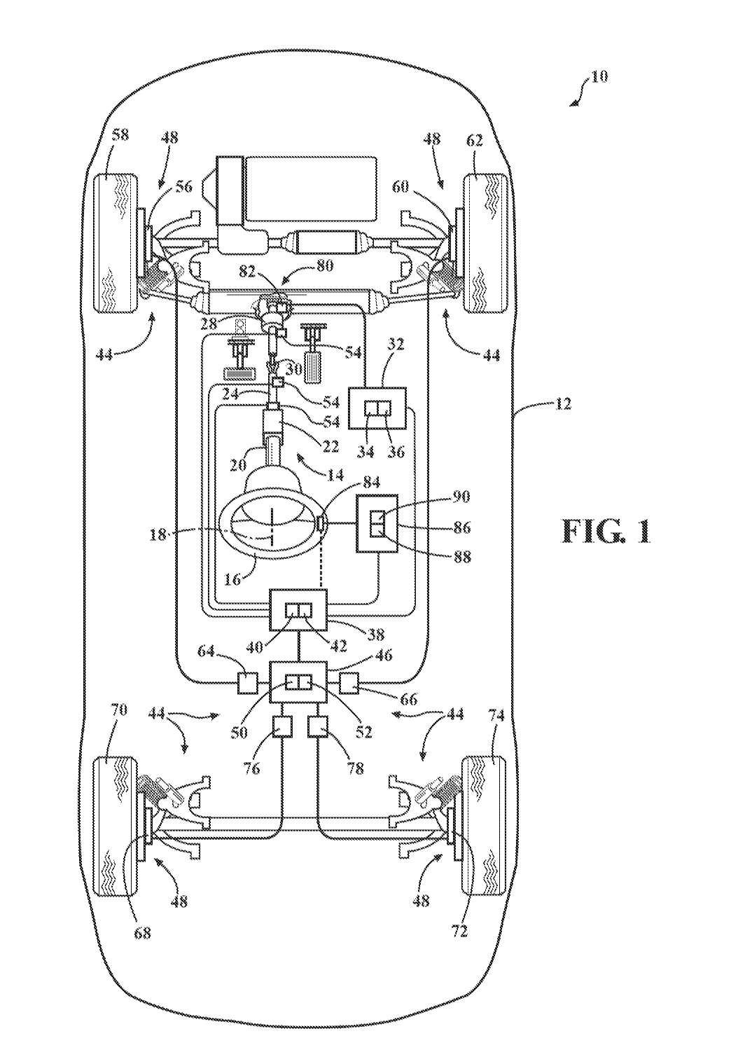

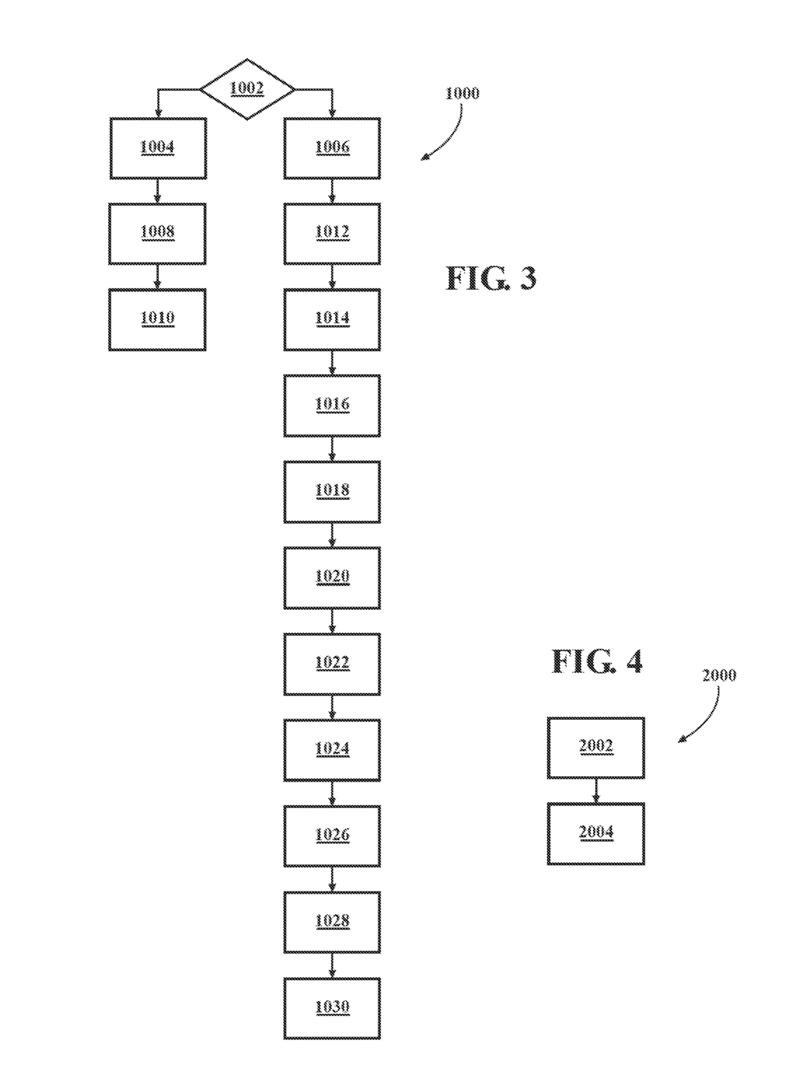

Referring to the Figures, wherein like numerals indicate like or corresponding parts throughout the several views, a steering system 10 for an autonomously driven vehicle 12 is shown in FIG. 1. Furthermore, as shown in FIGS. 3 and 4, the present disclosure also provides methods 1000, 2000 of steering the autonomously driven vehicle 12, which will be discussed in detail below. Specifically, the steering system 10 and the methods 1000, 2000 of steering the vehicle 12 disclosed herein provide a back-up system for the primary steering of the vehicle 12 in certain situations. For example, this back-up system can be activated when an interruption occurs in the primary steering of the vehicle 12.

Generally, the autonomously driven vehicle 12 can move and stop along a road, a street, etc. without being controlled or steered by a person or human in a driver's seat. In other words, a destination can be inputted or programed into a computer of the autonomously driven vehicle 12 and the vehicle 12 will drive itself along the road(s), etc. and arrive at the desired location without a human driver manually steering the vehicle 12. It is to be appreciated various sensors, controllers, etc. can be utilized to maintain the autonomously driven vehicle 12 in a desired lane on the road.

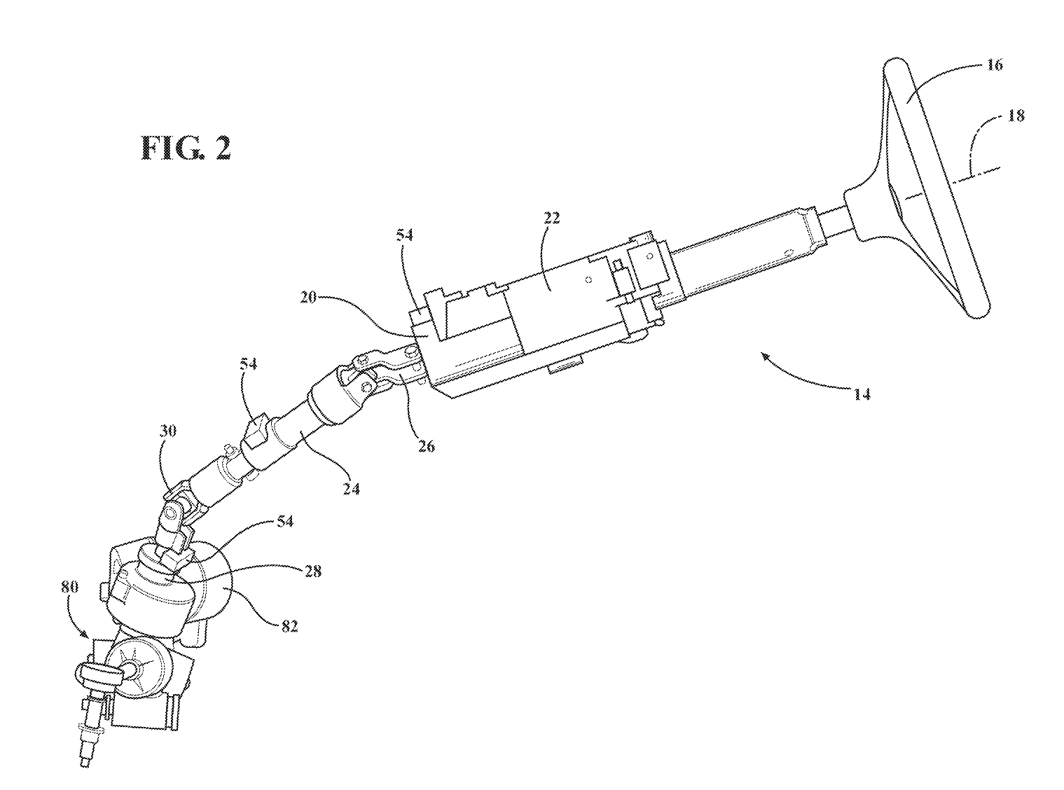

Referring to FIGS. 1 and 2, the steering system 10 includes a steering assembly 14. The steering assembly 14 steers or directs the vehicle 12 along the road(s), etc. to a desired location. The steering assembly 14 can include numerous components and some of these components are discussed below. For example, the steering assembly 14 includes a steering wheel 16 rotatable about a longitudinal axis 18. Traditionally, the steering wheel 16 is utilized by the driver to steer a non-autonomously driven vehicle. In certain situations, as discussed below, the steering wheel 16 of the autonomously driven vehicle 12 discussed herein can be engaged to manually steer the vehicle 12. For example, the steering wheel 16 can be touched or grasped by the driver to manually steer the vehicle 12 in certain situations, such as when the primary steering of the vehicle 12 is interrupted, as discussed below.

Turning to FIG. 2, the steering assembly 14 can include a steering column 20 rotatable about the longitudinal axis 18. Generally, the steering wheel 16 is attached to the steering column 20 such that the steering wheel 16 and the steering column 20 commonly rotate about the longitudinal axis 18. Therefore, rotation of one of the steering wheel 16 and the steering column 20 causes rotation of the other one of the steering wheel 16 and the steering column 20. In other words, the steering wheel 16 and the steering column 20 rotate in unison. Optionally, the steering column 20 can be a tilting and/or telescoping steering column 20. As such, the steering column 20 can tilt, for example up and down, relative to the driver's seat to position the steering wheel 16 in a desired location. Furthermore, the steering column 20 can telescope, for example back and forth, relative to the driver's seat to position the steering wheel 16 in a desired location.

Generally, the steering column 20 can include a bracket 22 coupled to the vehicle 12 to support the steering column 20. In other words, the bracket 22 is attached or mounted to the vehicle 12 and supports the steering column 20 such that the steering column 20 can rotate independently of the bracket 22. For example, in certain embodiments, the steering column 20 can tilt and/or telescope relative to the bracket 22. It is to be appreciated that the steering column 20 can include other components not specifically discussed herein.

Continuing with FIG. 2, the steering assembly 14 can include an intermediate shaft 24 operatively coupled to the steering column 20 such that the intermediate shaft 24 and the steering column 20 commonly rotate. In other words the steering column 20 and the intermediate shaft 24 rotate in unison. Therefore, the steering wheel 16, the steering column 20 and the intermediate shaft 24 rotate in unison. It is to be appreciated that the intermediate shaft 24 can be operatively coupled to the steering column 20 by a universal joint 26 or any other suitable component(s).

In addition, continuing with FIG. 2, the steering assembly 14 can include a steering gear mechanism 28 operatively coupled to the intermediate shaft 24, with the intermediate shaft 24 disposed between the steering gear mechanism 28 and the steering column 20. The intermediate shaft 24 can be operatively coupled to the steering gear mechanism 28 by a universal joint 30 or any other suitable component(s). Therefore, for example, distal ends of the intermediate shaft 24 have the universal joints 26, 30. The steering gear mechanism 28 will be discussed further below.

Turning to FIG. 1, the steering system 10 also includes a power steering controller 32 coupled to the steering assembly 14 and having a first mode and a second mode. Therefore, the power steering controller 32 is in communication with the steering assembly 14 and monitors the steering assembly 14. Generally, the first and second modes are different from each other. For example, the first mode can be when the steering assembly 14 is functioning in a first operating condition and the second mode can be when the steering assembly 14 is functioning in a second operating condition. The first operating condition can be when the vehicle 12 is being operated without the steering wheel 16 being engaged by the driver. The second operating condition can be when the vehicle 12 is to be steered by the driver, such as, for example, when there has been the interruption in the primary steering of the vehicle 12. The first and second operating conditions are discussed further below. Optionally, the power steering controller 32 can be disposed in a power steering module which is coupled to the steering assembly 14. The power steering module can house other steering components, such as sensors, etc., or components not specifically discussed herein.

The power steering controller 32, shown schematically in FIG. 1, can be embodied as a digital computer device or multiple such devices in communication with the various components of the vehicle 12. Structurally, the power steering controller 32 can include at least one microprocessor 34 along with sufficient tangible, non-transitory memory 36, e.g., read-only memory (ROM), flash memory, optical memory, additional magnetic memory, etc. The power steering controller 32 can also include any required random access memory (RAM), electrically-programmable read only memory (EPROM), a high-speed clock, analog-to-digital (A/D) and/or digital-to-analog (D/A) circuitry, and any input/output circuitry or devices, as well as any appropriate signal conditioning and buffer circuitry. Instructions for executing the methods 1000, 2000 for steering the vehicle 12 are recorded in the memory 36 and executed as needed via the microprocessor(s) 34.

The steering system 10 further includes a main controller 38 in communication with the power steering controller 32. The main controller 38, shown schematically in FIG. 1, can be embodied as a digital computer device or multiple such devices in communication with the various components of the vehicle 12. Structurally, the main controller 38 can include at least one microprocessor 40 along with sufficient tangible, non-transitory memory 42, e.g., read-only memory (ROM), flash memory, optical memory, additional magnetic memory, etc. The main controller 38 can also include any required random access memory (RAM), electrically-programmable read only memory (EPROM), a high-speed clock, analog-to-digital (A/D) and/or digital-to-analog (D/A) circuitry, and any input/output circuitry or devices, as well as any appropriate signal conditioning and buffer circuitry. Instructions for executing the methods 1000, 2000 for steering the vehicle 12 are recorded in the memory 42 and executed as needed via the microprocessor(s) 40. Optionally, the main controller 38 can be disposed in a controller module and other components, such as sensors, etc., or components not specifically discussed herein, can be disposed in the controller module.

In addition, the steering system 10 includes a brake system 44 in communication with the main controller 38. More specifically, the brake system 44 can include a brake controller 46 in communication with the main controller 38. The brake system 44 further includes a brake device 48 in communication with the main controller 38. More specifically, the brake controller 46 can be in communication with the main controller 38 and the brake device 48. The brake controller 46, shown schematically in FIG. 1, can be embodied as a digital computer device or multiple such devices in communication with the various components of the vehicle 12. Structurally, the brake controller 46 can include at least one microprocessor 50 along with sufficient tangible, non-transitory memory 52, e.g., read-only memory (ROM), flash memory, optical memory, additional magnetic memory, etc. The brake controller 46 can also include any required random access memory (RAM), electrically-programmable read only memory (EPROM), a high-speed clock, analog-to-digital (A/D) and/or digital-to-analog (D/A) circuitry, and any input/output circuitry or devices, as well as any appropriate signal conditioning and buffer circuitry. Instructions for executing the methods 1000, 2000 for steering the vehicle 12 are recorded in the memory 52 and executed as needed via the microprocessor(s) 50.

Generally, the brake device 48 is operable in a first phase to brake the vehicle 12 when the power steering controller 32 is in the first mode and a second phase to steer the vehicle 12 when the power steering controller 32 is in the second mode. For example, the brake device 48 operates in the first phase to stop movement of the vehicle 12, slow the vehicle 12 down and prevent movement of the vehicle 12 when the steering assembly 14 is functioning in the first operating condition such that the vehicle 12 is being steered without the steering wheel 16 being engaged by the driver. Therefore, when the brake device 48 is operating in the first phase, the steering assembly 14 is steering the vehicle 12 without utilizing the driver. Furthermore, for example, the brake device 48 operates in the second phase to steer the vehicle 12 or guide the vehicle 12 along a road when the steering assembly 14 is functioning in the second operating condition such that the vehicle 12 is to be steered by the driver. The main controller 38 is in communication with the brake controller 46 to signal to the brake controller 46 which of the phases the brake device 48 is to be operating in. Therefore, the brake controller 46, in response to the main controller 38, signals the brake device 48 to operate in one of the first and second phases.

Referring to FIGS. 1 and 2, the steering system 10 also includes a friction device 54 coupled to the steering assembly 14. The friction device 54 is movable between a disengaged position releasing the steering assembly 14 to allow rotation of the steering wheel 16 about the longitudinal axis 18 and an engaged position engaging the steering assembly 14 to secure the steering wheel 16 in an initial position. The main controller 38 is in communication with the friction device 54 to signal the friction device 54 to actuate to the disengaged position when the power steering controller 32 is in the first mode and the brake device 48 is in the first phase, and signal the friction device 54 to actuate to the engaged position to secure the steering wheel 16 in the initial position when the power steering controller 32 is in the second mode and the brake device 48 is in the second phase to allow the brake device 48 to steer the vehicle 12. Therefore, when the friction device 54 is in the disengaged position, the steering wheel 16 can rotate about the longitudinal axis 18 freely or unrestricted. Furthermore, when the friction device 54 is in the engaged position, the steering wheel 16 is secured in the initial position such that the steering wheel 16 cannot be rotated freely, and therefore, rotation of the steering wheel 16 is restricted.

As shown in FIGS. 1 and 2, the friction device 54 can be coupled to the steering assembly 14 in various locations. For example, in one embodiment, the friction device 54 is coupled to the steering column 20 such that the friction device 54 engages the steering column 20 when in the engaged position to secure the steering wheel 16 in the initial position. As another example, in one embodiment, the friction device 54 is coupled to the intermediate shaft 24 such that the friction device 54 engages the intermediate shaft 24 when in the engaged position to secure the steering wheel 16 in the initial position. As yet another example, in one embodiment, the friction device 54 is coupled to the steering gear mechanism 28 such that the friction device 54 engages the steering gear mechanism 28 when in the engaged position to secure the steering wheel 16 in the initial position. Generally, one friction device 54 is coupled to the steering assembly 14 in one of the above identified locations. It is to be appreciated that more than one friction device 54 can be coupled to the steering assembly 14 in one or more of the above identified locations. Furthermore, the friction device 54 is shown schematically in FIGS. 1 and 2 for illustrative purposes only and can be any suitable configuration, such as for example, a clutch, a damper, a magnetic device, an electromagnetic device, friction plates, belt-driven friction device, etc.

Turning to FIG. 1, the brake device 48 can include a first brake 56 operatively coupled to a first wheel 58 and a second brake 60 operatively coupled to a second wheel 62. For example, the first and second wheels 58, 62 can be the front wheels of a 3 or 4-wheeled vehicle 12. It is to be appreciated that the first wheel 58 can be the front wheel and the second wheel 62 can be the rear wheel of a 2 or 3-wheeled vehicle 12.

Furthermore, the brake system 44 can include a first sensor 64 in communication with the brake controller 46 and the first brake 56 of the first wheel 58 for selectively actuating the first brake 56 when the brake device 48 is in the second phase. In addition, the brake system 44 can include a second sensor 66 in communication with the brake controller 46 and the second brake 60 of the second wheel 62 for selectively actuating the second brake 60 when the brake device 48 is in the second phase. Therefore, the first and second sensors 64, 66 are each in communication with the brake controller 46 such that the brake controller 46 signals to the first and/or second sensors 64, 66 which of the first and/or second brakes 56, 60 are to be actuated. As such, when the brake device 48 is in the second phase, the steering assembly 14 is functioning in the second operating condition such that the vehicle 12 is being steered by the brake device 48 until the driver engages the steering wheel 16 as discussed below. It is to be appreciated that the first and second sensors 64, 66 can also function as anti-lock brake sensors to slow the vehicle 12 when, for example, sliding on ice, etc.

Continuing with FIG. 1, the brake device 48 can also include a third brake 68 operatively coupled to a third wheel 70 and a fourth brake 72 operatively coupled to a fourth wheel 74. For example, the third and fourth wheels 70, 74 can be the rear wheels of a 3 or 4-wheeled vehicle 12.

Additionally, the brake system 44 can include a third sensor 76 in communication with the brake controller 46 and the third brake 68 of the third wheel 70 for selectively actuating the third brake 68 when the brake device 48 is in the second phase. The brake system 44 can further include a fourth sensor 78 in communication with the brake controller 46 and the fourth brake 72 of the fourth wheel 74 for selectively actuating the fourth brake 72 when the brake device 48 is in the second phase. Therefore, the third and fourth sensors 76, 78 are each in communication with the brake controller 46 such that the brake controller 46 signals to the third and/or fourth sensors 76, 78 which of the third and/or fourth brakes 68, 72 are to be actuated. As such, when the brake device 48 is in the second phase, the steering assembly 14 is functioning in the second operating condition such that the vehicle 12 is being steered by the brake device 48 until the driver engages the steering wheel 16 as mentioned above. It is to be appreciated that the third and fourth sensors 76, 78 can also function as anti-lock brake sensors to slow the vehicle 12 when, for example, sliding on ice, etc. Optionally, the brake controller 46 and/or the first, second, third and fourth sensors 64, 66, 76, 78 can be disposed in a brake module. It is to also be appreciated that other braking components, such as sensors, etc., or components not specifically discussed herein, can be disposed in the brake module.

The brake controller 46 can signal at least one of the first, second, third and fourth sensors 64, 66, 76, 78 to actuate respective at least one of the first, second, third and fourth brakes 56, 60, 68, 72 to steer the vehicle 12 when the brake device 48 is in the second phase. When the friction device 54 is in the engaged position such that the steering wheel 16 is secured in the initial position, and when one or more of the first, second, third and fourth brakes 56, 60, 68, 72 are actuated, one or more yaw moments are created or generated to steer the vehicle 12. In other words, one or more brake torque yaw moments can be generated by the brake system 44 to steer the vehicle 12 when the brake device 48 is in the second phase. Maintaining the steering wheel 16 in the initial position when the brake device 48 is in the second phase prevents or minimizes the steering wheel 16 from rotating due to torques urging the steering wheel 16 to self-align. Rotation of the steering wheel 16 can counteract the yaw movement created by the brakes 56, 60, 68, 72 when the brake device 48 is in the second phase by self-aligning; therefore, the steering wheel 16 is secured in the initial position to minimize such counteraction. As such, when the steering wheel 16 is secured in the initial position, this simulates the driver holding or grasping the steering wheel 16. Thus, securing the steering wheel 16 in the initial position allows the brake device 48 to steer the vehicle 12 with minimal influence by the steering wheel 16.

Continuing with FIG. 1, the steering assembly 14 can include a rack and pinion apparatus 80 operatively coupled to the steering gear mechanism 28 and extending outwardly away from the steering assembly 14 to distal ends opposing each other. Generally, the first and second wheels 58, 62 are operatively coupled to respective distal ends. In other words, the first and second wheels 58, 62 are operatively coupled to the rack and pinion apparatus 80.

Furthermore, the steering gear mechanism 28 includes an electric motor 82 to assist in moving the rack and pinion apparatus 80 in response to rotation of the steering wheel 16 to pivot the first and second wheels 58, 62 and steer the vehicle 12. Therefore, the electric motor 82 is operatively coupled to the steering gear mechanism 28 and thus the rack and pinion apparatus 80 to assist in rotating the steering wheel 16. As such, actuation of the steering gear mechanism 28 causes the electric motor 82 to be actuated to assist in moving the rack and pinion apparatus 80 and thus move the first and second wheels 58, 62 accordingly. Generally, the power steering controller 32 is in communication with the electric motor 82; and thus, the power steering controller 32 can signal to the electric motor 82 to selectively actuate. As such, the electric motor 82 acts as a power steering assist for the steering assembly 14.

The power steering controller 32 can detect whether the steering assembly 14 is functioning in the first or second operating conditions. As such, the power steering controller 32 signals the main controller 38 which of the first and second operating conditions the steering assembly 14 is functioning in. For example, if the power steering controller 32 detects that the electric motor 82 did not actuate to assist the rack and pinion apparatus 80, and thus the steering wheel 16, the power steering controller 32 will signal to the main controller 38 that the steering assembly 14 is in the second operating condition. The electric motor 82 can be part of the primary steering of the vehicle 12, therefore, if the power steering controller 32 detects that there is the interruption with the function of the electric motor 82, the power steering controller 32 will signal to the main controller 38 that the back-up system is to be activated to steer the vehicle 12. It is to be appreciated that the primary steering of the vehicle 12 can include one or more of the electric motor 82, the rack and pinion apparatus 80, the steering gear mechanism 28, the intermediate shaft 24, and the steering column 20.

Referring to FIG. 1, the steering system 10 can further include a contact sensor 84 coupled to the steering wheel 16 to detect contact on the steering wheel 16. Generally, the contact sensor 84 is in communication with the main controller 38. Under certain conditions, the contact sensor 84 communicates with the main controller 38 such that contact on the steering wheel 16 signals the main controller 38 to communicate to the brake device 48 to switch from the second phase back to the first phase and communicate to the friction device 54 to switch from the engaged position back to the disengaged position. Simply stated, when the power steering controller 32 is in the second mode, once contact is detected on the steering wheel 16 by the driver, the steering wheel 16 is not secured in the initial position anymore and the driver can rotate the steering wheel 16 to steer the vehicle 12. It is to be appreciated that if the steering wheel 16 is being contacted but the contact sensor 84 does not signal the main controller 38 of this contact, the friction being applied to the steering assembly 14 by the friction device 54 can be overridden by the driver such that the driver can steer the vehicle 12. In other words, the friction being applied to the steering assembly 14 can secure the steering wheel 16 in the initial position while also allowing the driver to overcome this friction and turn the steering wheel 16 to steer the vehicle 12 if the friction device 54 remains in the engaged position after the steering wheel 16 has been touched.

Continuing with FIG. 1, the steering system 10 can further include a steering wheel controller 86 in communication with the contact sensor 84 and the main controller 38. Therefore, in certain embodiments, when the power steering controller 32 is in the second mode, when contact is detected on the steering wheel 16, the contact sensor 84 communicates to the steering wheel controller 86 of the contact and the steering wheel controller 86 communicates to the main controller 38 that contact has been detected by the contact sensor 84. Therefore, the contact sensor 84 and the main controller 38 can be in direct communication with each other as indicated by the dashed line therebetween in FIG. 1 or the contact sensor 84 and the main controller 38 can be in communication with each other through the steering wheel controller 86 as indicated by the solid line going from the contact sensor 84 to the steering wheel controller 86 and the main controller 38 in FIG. 1.

The steering wheel controller 86, shown schematically in FIG. 1, can be embodied as a digital computer device or multiple such devices in communication with the various components of the vehicle 12. Structurally, the steering wheel controller 86 can include at least one microprocessor 88 along with sufficient tangible, non-transitory memory 90, e.g., read-only memory (ROM), flash memory, optical memory, additional magnetic memory, etc. The steering wheel controller 86 can also include any required random access memory (RAM), electrically-programmable read only memory (EPROM), a high-speed clock, analog-to-digital (A/D) and/or digital-to-analog (D/A) circuitry, and any input/output circuitry or devices, as well as any appropriate signal conditioning and buffer circuitry. Instructions for executing the methods 1000, 2000 for steering the vehicle 12 are recorded in the memory 90 and executed as needed via the microprocessor(s) 88. Optionally, the steering wheel controller 86 can be disposed in a steering wheel module and other components, such as sensors, etc., or components not specifically discussed herein, can be disposed in the steering wheel 16 module.

Referring to FIG. 3, the present disclosure also provides the method 1000 of steering the autonomously driven vehicle 12, as briefly mentioned above. The method 1000 includes determining 1002 that the power steering controller 32 is in one of the first mode and the second mode different from the first mode. As discussed above, the first mode can be when the steering assembly 14 is functioning in the first operating condition and the second mode can be when the steering assembly 14 is functioning in the second operating condition. As also discussed above, for example, the first operating condition occurs when the vehicle 12 is being operated without the steering wheel 16 being engaged by the driver and the second operating condition occurs when the vehicle 12 is to be steered by the driver.

The method 1000 also includes signaling 1004 the main controller 38 that the power steering controller 32 is in the first mode and signaling 1006 the main controller 38 that the power steering controller 32 is in the second mode. Therefore, the main controller 38 and the power steering controller 32 are in continuous communication with each other such that the main controller 38 continuously receives signals from the power steering controller 32 to indicate which of the modes the power steering controller 32 is in. Depending on which of the modes the power steering controller 32 is in, will determine whether the vehicle 12 is being operated in the first operating condition or the second operating condition.

When the power steering controller 32 is in the first mode and the steering assembly 14 is functioning in the first operating condition, in this condition, the method 1000 further includes signaling 1008 the brake device 48, via the main controller 38, to operate in the first phase in response to the power steering controller 32 being in the first mode. Furthermore, the method 1000 includes signaling 1010 the friction device 54, via the main controller 38, to operate in the disengaged position in response to the power steering controller 32 being in the first mode such that the steering wheel 16 is rotatable. Therefore, generally, the brake device 48 and the friction device 54 are each continuously in communication with the main controller 38 such that the main controller 38 continuously signals which phase the brake device 48 is to be operating in and which position the friction device 54 is to be operating in. The brake device 48 remains in the first phase when the power steering controller 32 remains in the first mode. Similarly, the friction device 54 remains in the disengaged position when the power steering controller 32 remains in the first mode.

When the brake device 48 is in the first phase and the friction device 54 is in the disengaged position, the steering wheel 16 is rotatable. Simply stated, when the friction device 54 is in the disengaged position, the steering wheel 16 can rotate about the longitudinal axis 18 freely or unrestricted. As such, when the power steering controller 32 is in the first mode, the steering assembly 14 is operating in the first operating condition such that the vehicle 12 is being steered without the steering wheel 16 being engaged by the driver, with the brake device 48 operating to slow or stop the vehicle 12 as desired while the steering assembly 14 operates to steer the vehicle 12. Therefore, for example, when the electric motor 82 is assisting in moving the rack and pinion apparatus 80, and thus, assisting in rotating the steering wheel 16, the power steering controller 32 will remain in the first mode and the vehicle 12 will continue to its destination without being manually steered by the driver.

When the main controller 38 has been signaled that the power steering controller 32 is in the second mode and the steering assembly 14 is functioning in the second operating condition, in this condition, the power steering controller 32 has switched from the first mode to the second mode. For example, the power steering controller 32 can switch from the first mode to the second mode when the electric motor 82 does not actuate to move the rack and pinion. In other words, the second mode can occur when there is the interruption in the power steering of the vehicle 12. Hence, when the power steering controller 32 is in the second mode, the driver is to manually steer the vehicle 12 as discussed below. Generally, the first mode occurs before the second mode.

The method 1000 further includes signaling 1012 the brake device 48, via the main controller 38, to switch from the first phase to operate in the second phase in response to the power steering controller 32 being in the second mode such that the brake device 48 steers the vehicle 12 in the second phase. More specifically, signaling 1012 the brake device 48, via the main controller 38, to switch from the first phase to operate in the second phase in response to the power steering controller 32 being in the second mode can include signaling the brake controller 46, via the main controller 38, to activate the brake device 48 to operate in the second phase in response to the power steering controller 32 being in the second mode. Therefore, as discussed above, the brake device 48 is in continuous communication with the main controller 38 such that the main controller 38 continuously signals which phase the brake device 48 is to be operating in. Furthermore, the method 1000 can include actuating 1014 one or more of the first, second, third and fourth brakes 56, 60, 68, 72 in response to the brake device 48 being in the second phase to steer the vehicle 12. Therefore, actuating 1014 one or more of the first, second third and fourth brakes 56, 60, 68, 72 in response to the brake device 48 being in the second phase can include actuating one or more of the first, second, third and fourth brakes 56, 60, 68, 72 to generate at least one yaw moment to steer the vehicle 12 when the interruption occurs in the primary steering of the vehicle 12.

The method 1000 also includes actuating 1016 the friction device 54 from the disengaged position to the engaged position in response to the power steering controller 32 being in the second mode. More specifically, actuating 1016 the friction device 54 from the disengaged position to the engaged position in response to the power steering controller 32 being in the second mode can include signaling the friction device 54, via the main controller 38, to actuate from the disengaged position to the engaged position in response to the power steering controller 32 being in the second mode. As discussed above, the friction device 54 is in continuous communication with the main controller 38 such that the main controller 38 continuously signals which position the friction device 54 is to be operating in. Generally, in certain embodiments, signaling the brake controller 46, via the main controller 38, to activate the brake device 48 to operate in the second phase in response to the power steering controller 32 being in the second mode and signaling the friction device 54, via the main controller 38, to actuate from the disengaged position to the engaged position in response to the power steering controller 32 being in the second mode occurs simultaneously through communication with the main controller 38.

Furthermore, the method 1000 includes engaging 1018 the steering assembly 14 with the friction device 54 when the friction device 54 is in the engaged position to secure the steering wheel 16 in the initial position such that the brake device 48 steers the vehicle 12 in the second phase. As such, in one embodiment, engaging 1018 the steering assembly 14 with the friction device 54 can include engaging the steering column 20 with the friction device 54 when the friction device 54 is in the engaged position to secure the steering wheel 16 in the initial position. In another embodiment, engaging 1018 the steering assembly 14 with the friction device 54 can include engaging the intermediate shaft 24 with the friction device 54 when the friction device 54 is in the engaged position to secure the steering wheel 16 in the initial position. In yet another embodiment, engaging 1018 the steering assembly 14 with the friction device 54 can include engaging the steering gear mechanism 28 with the friction device 54 when the friction device 54 is in the engaged position to secure the steering wheel 16 in the initial position.

As discussed above, when the friction device 54 is in the engaged position such that the steering wheel 16 is secured in the initial position, and when one or more of the first, second, third and fourth brakes 56, 60, 68, 72 are actuated, one or more yaw moments are created or generated to steer the vehicle 12. Maintaining the steering wheel 16 in the initial position when the brake device 48 is in the second phase prevents or minimizes the steering wheel 16 from rotating due to torques urging the steering wheel 16 to self-align. Rotation of the steering wheel 16 can counteract the yaw movement created by the brakes 56, 60, 68, 72 when the brake device 48 is in the second phase by self-aligning; therefore, the steering wheel 16 is secured in the initial position to minimize such counteraction. As such, when the steering wheel 16 is secured in the initial position, this simulates the driver holding the steering wheel 16 to allow the brake device 48 to steer the vehicle 12 until the driver actually contacts or touches the steering wheel 16 as discussed below.

The method 1000 can further include coupling 1020 the contact sensor 84 to the steering wheel 16, with the contact sensor 84 in communication with the main controller 38. In addition, the method 1000 can include detecting 1022 contact on the steering wheel 16, via the contact sensor 84, when the power steering controller 32 is in the second mode. The method 1000 can also include signaling 1024 the main controller 38, via the contact sensor 84, that contact is detected on the steering wheel 16 when the power steering controller 32 is in the second mode. For example, when the driver contacts, engages or touches the steering wheel 16 when the power steering controller 32 is in the second mode, the contact sensor 84 detects this contact or touching on the steering wheel 16 and signals the main controller 38 that the steering wheel 16 is being contacted or touched. It is to be appreciated that the main controller 38 can be signaled through the steering wheel controller 86 whether the contact sensor 84 detects contact on the steering wheel 16. Therefore, signaling 1024 the main controller 38, via the contact sensor 84, that contact is detected can include signaling the main controller 38, via the steering wheel controller 86, that contact is detected on the steering wheel 16 by the contact sensor 84. Until contact is detected on the steering wheel 16 and communicated to the main controller 38, the brake device 48 will continue to operate in the second phase and the friction device 54 will continue to operate in the engaged position.

When contact is detected by the contact sensor 84 and the driver has taken over manually steering the vehicle 12 while the power steering controller 32 remains in the second mode, in this condition, the method 1000 can include signaling 1026 the brake device 48, via the main controller 38, to switch from the second phase back to operation in the first phase in response to contact on the steering wheel 16 when the power steering controller 32 is in the second mode. More specifically, signaling 1026 the brake device 48, via the main controller 38, to switch from the second phase back to operation in the first phase in response to contact on the steering wheel 16 can include signaling the brake controller 46, via the main controller 38, to activate the brake device 48 to operate in the first phase in response to contact on the steering wheel 16 when the power steering controller 32 is in the second mode. Therefore, when the brake device 48 switches back to the first phase, the brake device 48 is no longer steering the vehicle 12. As such, for example, when the brake device 48 is in the first phase, the brakes 56, 60, 68, 72 can slow or stop the vehicle 12.

Furthermore, the method 1000 can include actuating 1028 the friction device 54 from the engaged position back to the disengaged position in response to contact on the steering wheel 16 when the power steering controller 32 is in the second mode. More specifically, actuating 1028 the friction device 54 from the engaged position back to the disengaged position in response to contact on the steering wheel 16 can include signaling the friction device 54, via the main controller 38, to actuate from the engaged position back to the disengaged position in response to contact on the steering wheel 16 when the power steering controller 32 is in the second mode. Generally, in certain embodiments, signaling the brake controller 46, via the main controller 38, to activate the brake device 48 to operate in the first phase in response to contact on the steering wheel 16 and signaling the friction device 54, via the main controller 38, to actuate from the engaged position back to the disengaged position in response to contact on the steering wheel 16 occurs simultaneously through communication with the main controller 38. Therefore, when the friction device 54 is in the disengaged position, the drive can rotate the steering wheel 16 to manually steer the vehicle 12.

The method 1000 can further include disengaging 1030 the steering assembly 14 with the friction device 54 when the friction device 54 is in the disengaged position to allow rotation of the steering wheel 16 when the brake device 48 is back in the first phase. As such, in one embodiment, disengaging 1030 the steering assembly 14 with the friction device 54 can include disengaging the steering column 20 with the friction device 54 when the friction device 54 is in the disengaged position to allow rotation of the steering wheel 16 when the brake device 48 is back in the first phase. In another embodiment, disengaging 1030 the steering assembly 14 with the friction device 54 can include disengaging the intermediate shaft 24 with the friction device 54 when the friction device 54 is in the disengaged position to allow rotation of the steering wheel 16 when the brake device 48 is back in the first phase. In yet another embodiment, disengaging 1030 the steering assembly 14 with the friction device 54 can include disengaging the steering gear mechanism 28 with the friction device 54 when the friction device 54 is in the disengaged position to allow rotation of the steering wheel 16 when the brake device 48 is back in the first phase. Therefore, as discussed above, when the friction device 54 is in the disengaged position, the driver can rotate the steering wheel 16 to manually steer the vehicle 12 while the power steering controller 32 remains in the second mode.

The present disclosure further provides another method 2000 of steering the autonomously driven vehicle 12, as briefly mentioned above. The method 2000 includes actuating 2002 at least one of the first brake 56 and the second brake 60 to generate at least one yaw moment to steer the vehicle 12 when the interruption occurs in the primary steering of the vehicle 12. More specifically, actuating 2002 the at least one of the first and second brakes 56, 60 to generate the at least one yaw moment can include actuating at least one of the first, second, third and fourth brakes 56, 60, 68, 72 to generate at least one yaw moment to steer the vehicle 12 when the interruption occurs in the primary steering of the vehicle 12.

The method 2000 also includes engaging 2004 the steering assembly 14 with the friction device 54 to secure the steering wheel 16 in the initial position when actuating the at least one of the first and second brakes 56, 60 to steer the vehicle 12. More specifically, engaging 2004 the steering assembly 14 with the friction device 54 to secure the steering wheel 16 in the initial position can include engaging 2004 the steering assembly 14 with the friction device 54 to secure the steering wheel 16 in the initial position when actuating the at least one of the first, second, third and fourth brakes 56, 60, 68, 72 to steer the vehicle 12.

Furthermore, in one embodiment, engaging 2004 the steering assembly 14 with the friction device 54 can include engaging the steering column 20 with the friction device 54 to secure the steering wheel 16 in the initial position. In another embodiment, engaging 2004 the steering assembly 14 with the friction device 54 can include engaging the intermediate shaft 24 with the friction device 54 to secure the steering wheel 16 in the initial position. In yet another embodiment, engaging 2004 the steering assembly 14 with the friction device 54 can include engaging the steering gear mechanism 28 with the friction device 54 to secure the steering wheel 16 in the initial position.

It is to be appreciated that the order or sequence of performing the methods 1000, 2000 as identified in the flowcharts of FIGS. 3 and 4 are for illustrative purposes and other orders or sequences are within the scope of the present disclosure. It is to also be appreciated that the methods 1000, 2000 can include other features not specifically identified in the flowcharts of FIGS. 3 and 4. In addition, the method 2000 can include features of the method 1000, such as for example, determining that the power steering controller 32 is in one of the first mode and the second mode, the main controller 38 can signal and be signaled, the brake device 48 and the brake controller 46 can each signal and be signaled, the friction device 54 can be signaled and actuated, the contact sensor 84 can be coupled to the steering wheel 16 and detect/signal, the steering assembly 14 can be disengaged, etc.

While the best modes for carrying out the disclosure have been described in detail, those familiar with the art to which this disclosure relates will recognize various alternative designs and embodiments for practicing the disclosure within the scope of the appended claims.

1. A steering system for an autonomously driven vehicle, the system comprising:
a steering assembly including a steering wheel rotatable about a longitudinal axis;
a power steering controller coupled to the steering assembly and having a first mode and a second mode;
a main controller in communication with the power steering controller;
a brake system in communication with the main controller and including a brake device in communication with the main controller, with the brake device operable in a first phase to brake the vehicle when the power steering controller is in the first mode and a second phase to steer the vehicle when the power steering controller is in the second mode; and
a friction device coupled to the steering assembly and movable between a disengaged position releasing the steering assembly to allow rotation of the steering wheel about the longitudinal axis and an engaged position engaging the steering assembly to secure the steering wheel in an initial position, and with the main controller in communication with the friction device to signal the friction device to actuate to the disengaged position when the power steering controller is in the first mode and the brake device is in the first phase, and signal the friction device to actuate to the engaged position to secure the steering wheel in the initial position when the power steering controller is in the second mode and the brake device is in the second phase to allow the brake device to steer the vehicle.

2. A system as set forth in claim 1 wherein the steering assembly includes a steering column rotatable about the longitudinal axis, with the steering wheel attached to the steering column such that the steering wheel and the steering column commonly rotate about the longitudinal axis.

3. A system as set forth in claim 2 wherein the friction device is coupled to the steering column such that the friction device engages the steering column when in the engaged position to secure the steering wheel in the initial position.

4. A system as set forth in claim 2 wherein the steering assembly includes an intermediate shaft operatively coupled to the steering column such that the intermediate shaft and the steering column commonly rotate.

5. A system as set forth in claim 4 wherein the friction device is coupled to the intermediate shaft such that the friction device engages the intermediate shaft when in the engaged position to secure the steering wheel in the initial position.

6. A system as set forth in claim 4 wherein the steering assembly includes a steering gear mechanism operatively coupled to the intermediate shaft, with the intermediate shaft disposed between the steering gear mechanism and the steering column.

7. A system as set forth in claim 6 wherein the friction device is coupled to the steering gear mechanism such that the friction device engages the steering gear mechanism when in the engaged position to secure the steering wheel in the initial position.

8. A system as set forth in claim 1 wherein the brake device includes a first brake operatively coupled to a first wheel and a second brake operatively coupled to a second wheel, and wherein the brake system includes a brake controller in communication with the main controller and the brake device, with the brake system further including a first sensor in communication with the brake controller and the first brake of the first wheel for selectively actuating the first brake when the brake device is in the second phase and the brake system includes a second sensor in communication with brake controller and the second brake of the second wheel for selectively actuating the second brake when the brake device is in the second phase.

9. A system as set forth in claim 8 wherein the brake device includes a third brake operatively coupled to a third wheel and a fourth brake operatively coupled to a fourth wheel, and wherein the brake system includes a third sensor in communication with the brake controller and the third brake of the third wheel for selectively actuating the third brake when the brake device is in the second phase and the brake system includes a fourth sensor in communication with the brake controller and the fourth brake of the fourth wheel for selectively actuating the fourth brake when the brake device is in the second phase.

10. A system as set forth in claim 9 wherein the brake controller signals at least one of the first, second, third and fourth sensors to actuate respective at least one of the first, second, third and fourth brakes to steer the vehicle when the brake device is in the second phase.

11. A system as set forth in claim 8 wherein the steering assembly includes a steering column rotatable about the longitudinal axis, with the steering wheel attached to the steering column such that the steering wheel and the steering column commonly rotate about the longitudinal axis, and wherein the steering assembly includes an intermediate shaft operatively coupled to the steering column such that the intermediate shaft and the steering column commonly rotate, and wherein the steering assembly includes a steering gear mechanism operatively coupled to the intermediate shaft, with the intermediate shaft disposed between the steering gear mechanism and the steering column.

12. A system as set forth in claim 11 wherein the steering assembly includes a rack and pinion apparatus operatively coupled to the steering gear mechanism and extending outwardly away from the steering assembly to distal ends opposing each other, with the first and second wheels operatively coupled to respective distal ends, and wherein the steering gear mechanism includes an electric motor to assist in moving the rack and pinion apparatus in response to rotation of the steering wheel to pivot the first and second wheels and steer the vehicle, with the power steering controller in communication with the electric motor.

13. A system as set forth in claim 1 further including a contact sensor coupled to the steering wheel to detect contact on the steering wheel, with the contact sensor in communication with the main controller such that contact on the steering wheel signals the main controller to communicate to the brake device to switch from the second phase back to the first phase and communicate to the friction device to switch from the engaged position back to the disengaged position.

14. A method of steering an autonomously driven vehicle, the method comprising:
determining that a power steering controller is in one of a first mode and a second mode different from the first mode;
signaling a main controller that the power steering controller is in the first mode;
signaling a brake device, via the main controller, to operate in a first phase in response to the power steering controller being in the first mode;
signaling a friction device, via the main controller, to operate in a disengaged position in response to the power steering controller being in the first mode such that a steering wheel is rotatable;
signaling the main controller that the power steering controller is in the second mode; and
signaling the brake device, via the main controller, to switch from the first phase to operate in a second phase in response to the power steering controller being in the second mode such that the brake device steers the vehicle in the second phase;
actuating the friction device from the disengaged position to the engaged position in response to the power steering controller being in the second mode;
engaging a steering assembly with the friction device when the friction device is in the engaged position to secure the steering wheel in an initial position such that the brake device steers the vehicle in the second phase.

15. A method as set forth in claim 14 wherein:
signaling the brake device, via the main controller, to switch from the first phase to operate in the second phase in response to the power steering controller being in the second mode includes signaling a brake controller, via the main controller, to activate the brake device to operate in the second phase in response to the power steering controller being in the second mode; and
actuating the friction device from the disengaged position to the engaged position in response to the power steering controller being in the second mode includes signaling the friction device, via the main controller, to actuate from the disengaged position to the engaged position in response to the power steering controller being in the second mode.

16. A method as set forth in claim 15 wherein signaling the brake controller, via the main controller, to activate the brake device to operate in the second phase in response to the power steering controller being in the second mode and signaling the friction device, via the main controller, to actuate from the disengaged position to the engaged position in response to the power steering controller being in the second mode occurs simultaneously through communication with the main controller.

17. A method as set forth in claim 14 further comprising:
coupling a contact sensor to the steering wheel, with the contact sensor in communication with the main controller;
detecting contact on the steering wheel, via the contact sensor, when the power steering controller is in the second mode; and
signaling the main controller, via the contact sensor, that contact is detected on the steering wheel when the power steering controller is in the second mode.

18. A method as set forth in claim 17 further comprising:
signaling the brake device, via the main controller, to switch from the second phase back to operation in the first phase in response to contact on the steering wheel when the power steering controller is in the second mode; and
actuating the friction device from the engaged position back to the disengaged position in response to contact on the steering wheel when the power steering controller is in the second mode.

19. A method as set forth in claim 18 wherein:
signaling the brake device, via the main controller, to switch from the second phase back to operation in the first phase in response to contact on the steering wheel includes signaling a brake controller, via the main controller, to activate the brake device to operate in the first phase in response to contact on the steering wheel when the power steering controller is in the second mode;
actuating the friction device from the engaged position back to the disengaged position in response to contact on the steering wheel includes signaling the friction device, via the main controller, to actuate from the engaged position back to the disengaged position in response to contact on the steering wheel when the power steering controller is in the second mode; and
signaling the brake controller, via the main controller, to activate the brake device to operate in the first phase in response to contact on the steering wheel and signaling the friction device, via the main controller, to actuate from the engaged position back to the disengaged position in response to contact on the steering wheel occurs simultaneously through communication with the main controller.

20. A method of steering an autonomously driven vehicle, the method comprising:
actuating at least one of a first brake and a second brake to generate at least one yaw moment to steer the vehicle when an interruption occurs in the primary steering of the vehicle; and
engaging a steering assembly with a friction device to secure a steering wheel in an initial position when actuating the at least one of the first and second brakes to steer the vehicle.
